(19) United States
(12) Patent Application Publication
(10) Pub. No.: US 2010/0315250 A1
(43) Pub. Date: Dec. 16, 2010

(54) ERROR DETECTION SYSTEM FOR G-SUIT

(75) Inventors: Fredrik FISK, Linkoping (SE); Karl-Gustav Fransson, Linkoping (SE); Rikard Johansson, Linkoping (SE)

Correspondence Address: VENABLE LLP, P.O. BOX 34385, WASHINGTON, DC, 20043-9998, US

(73) Assignee: SAAB AB, Linkoping (SE)

(21) Appl. No.: 12/813,140

(22) Filed: Jun. 10, 2010

(30) Foreign Application Priority Data
Jun. 10, 2009 (EP) 09162404.9

(51) Int. Cl. G08B 21/00; G06F 19/00; G01L 7/00; G06F 17/10

(52) U.S. Cl. 340/665; 702/19; 702/50; 703/2

(57) ABSTRACT

Systems and method for reliable detection of errors in a pressure control system for a pilot's G-suit. Alarm systems for generating alarm signals in case of malfunctioning of the pressure control system. The systems may prevent the pilot from passing out with a high safeguarding against failure of the system during critical maneuvers.

The invention relates to systems and methods for detecting a malfunction in the pressure control system of a pilot's G-suit. It also relates to systems and methods for issuing an alarm signal, if an error occurs.

### BACKGROUND OF THE INVENTION

Various systems for reducing the effects of high G-forces for aircraft pilots are known in the art.

For example, a system for reducing the effects of high G-forces on aircraft pilots is known from U.S. Pat. No. 4,906,990.A fluid pressure sensor is integrated within the pressure control loop, outside the G-suit. A G-suit is filled with liquid at an adjustable pressure. Additionally, the liquid pressure of the G-suit is monitored by a controller and an alarm signal is provided to the crew member in case the liquid pressure exceeds an acceptable tolerance of error.

US 2004/0254490 A1 describes a device for measuring the respiration rate and the breathing pattern of a person wearing an anti-blackout suit (G-suit). A pressure measurement cell is located inside a liquid-filled “vein” of the anti-blackout suit, not between the G-suit and the wearer of the G-suit. The anti-blackout suit contains a liquid at an adjustable pressure. An evaluation apparatus processes the measurement values. It is either linked via an optocoupler, a cable or wirelessly to the pressure measurement cell.

U.S. Pat. No. 4,243,024 discloses a G-protection system that regulates the air pressure within air bladders of trousers of a G-suit. The pressure transducer is located outside the G-suit.

GB 2334794 A describes a system for controlling the pressure of a fluid in a life support system including a G-suit. The pressure sensor is located in a hose connected to the G-suit.

The above error detection systems are physically connected to the G-suit or to the pressure control system. Error detection systems of the prior art are thus integral with the pressure control system or G-suit and can only be used for the specific system they are connected to. It is normally not possible to use the error detection system with different G-suits, different types of G-suits or different aircrafts, without significant effort. The error detection units of the prior art are not portable from one system to the other. The physical connection of prior art error detection systems to the G-suits or pressure control systems further makes it difficult to replace the complete error detection system, if it is defective.

### SUMMARY OF THE INVENTION

There is thus a need in the art for error detection systems which can be used with different G-suits and aircrafts. There is also a need for error detection systems which can easily be replaced, if defective.

The above problems are solved by the present invention by providing an error detection system having a pressure sensing unit adapted to be worn between the G-suit and the wearer, wherein the pressure sensing unit is not fixedly attached to the G-suit. The error detection system of the invention is thus a modular system which can be used with various G-suits and various aircrafts.

Error detection systems of the invention monitor the pressure in a G-suit, independently from the pressure sensors of the pressure control system, which is responsible for the pressure control of the G-suit. The pressure can be produced by pressurized gas or liquid. Error detection systems of the invention detect errors in a pressure control system without being part of it.

The error detection system comprises at least one pressure sensing unit, a transmitter and a receiver. The pressure sensing unit is preferably a portable device. The pressure sensing unit is adapted to be worn between the G-suit and a wearer of the G-suit. The pressure sensor is not fixedly attached to the G-suit. It is thus not un-releasably connected to the G-suit (this includes a releasable connection, as well as no physical connection at all).

The present invention hence relates to an error detection system for the detection of a malfunction of a pressure control system for a G-suit, said error detection system comprising:
a pressure sensing unit for establishing pressure data representing the pressure in said G-suit,
a transmitter communicating with said pressure sensing unit, said transmitter transmitting said pressure data to a receiver,
said receiver receiving said pressure data from said transmitter, and
an error detection unit connected to said receiver for detecting a malfunction of said pressure control system using said pressure data
characterized in that said pressure sensor unit is adapted to be worn between the G-suit and a wearer of said G-suit and said pressure sensing unit is not fixedly attached to said G-suit.

The invention further relates to methods for the detection of an error in a pressure control system of a G-suit, said method comprising:
establishing pressure data representing the pressure in a G-suit using a pressure sensing unit,
transmitting said pressure data by a transmitter connected to said pressure sensing unit;
receiving said pressure data by a receiver from said transmitter,
detecting a malfunction of said pressure control system from said pressure data using an error detection unit connected to said receiver,
characterized in that
said pressure data is established by a pressure sensor unit adapted to be worn between the G-suit and a wearer of the G-suit and said pressure sensing unit is not fixedly attached to the G-suit.

### BRIEF DESCRIPTION OF THE DRAWINGS

FIG. 1 is a schematic diagram of an error detection system of the invention.

FIG. 2 shows the placement of the pressure sensor unit.

FIG. 3 describes hypothetical a pressure versus time curve, during a flight maneuver.

### DETAILED DESCRIPTION OF THE INVENTION

The present invention relates to error detection systems and methods for detecting an error as defined in the independent claims.

In a preferred embodiment of the invention, the connection between receiver 16 and error detection unit 19 is a physical data connection, e.g. a wire. The connection may comprise a plug and socket connection. The connection may also be wireless.

The error detection unit 19 may be part of the aircraft computer 17. The error detection unit 19 detects a malfunction of the pressure control system.

A system according to the invention may have multiple pressure sensing units 13 connected to the transmitter 12. Systems of the invention can additionally comprise sensors for sensing biological data such as blood pressure, heart rate, body temperature, transpiration, breathing rate and other biological parameters.

The transmitter 12 may be adapted to process pressure data (and optionally biological data) received from the sensing units 13 before transmitting the data to the receiver 16. Data processing may consist of compression of data, or storage of data. The transmitter 12 is preferably equipped with a memory unit for recording data.

The transmitter 12 as well as the pressure sensing unit 13 may be equipped with a portable source of electrical energy, such as a battery, a rechargeable battery, or a fuel cell.

Transmitter 12 and the pressure sensing unit 13 may be separate units, but they may also be physically connected to each other. Preferably the transmitter 12 and the pressure sensing unit 13 are combined to a single unit, e.g. by providing the pressure sensing unit 13 and transmitter 12 in a single housing. This single unit preferably communicates directly with the receiver 16. Multiple of these combined units 12, 13 can be included in one error detection system of the invention.

According to another preferred embodiment of the invention the receiver 16 is physically connected to said error detection unit 19. The physical connection may be by wire, or by a transmission line on a printed circuit. The receiver 16 may, however, also stand in wireless connection to the transmitter 12.

A system of the present invention may also comprise an alarm system for providing an alarm signal upon detection of said malfunction.

The expected pressure of the G-suit in known flight maneuvers may also be stored in a look-up table. The access to this data preferably creates no substantial time delay.

The method may comprise issuing of an alarm signal upon detection of malfunction of the pressure control system.

The data communication between pressure sensing unit 13 and transmitter 12 as well as between transmitter 12 and receiver 16 can be implemented by a wired connection 25, but is preferably established by wireless connection.

The advantage of the wireless data communication is that bulky wiring is avoided. Wireless communication between small and portable components, according to the invention, gives the pilot more mobility in his cockpit.

Receiver 16 may use a physical data connection such as serial link 18 for data transfer to the error detection unit 19 and/or to the aircraft computer 17. Serial link 18 to aircraft computer 17 may be a standard external interface, for example RS422, RS485 or ARINC.

Multiple pressure sensing units 13 can be used. They can be placed at more than one location under the G-suit. This provides for a redundant, fault-tolerant and more accurate pressure sensing.

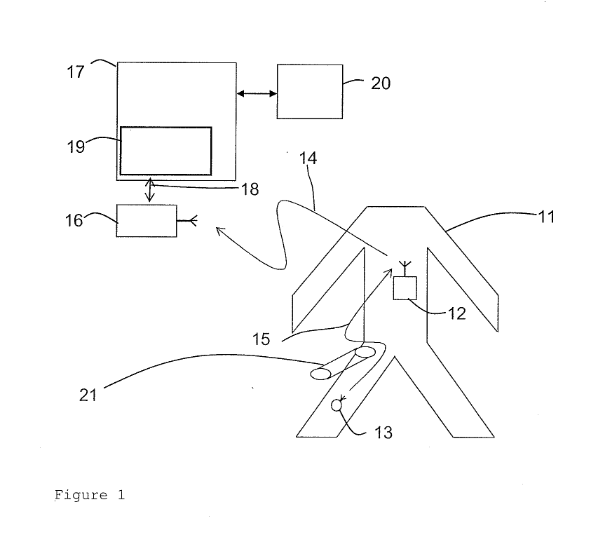

The present invention is shown in FIG. 1. The present invention relates to an error detection system comprising a pressure sensing unit 13, responsible for measuring the pressure in a G-suit, a transmitter 12 that transmits data from the pressure sensing unit 13 to a receiver 16, which forms the interface between transmitter 12 and error detection unit 19, which is shown as being integrated within the aircraft computer 17.

The error detection system has a modular structure. The modular structure allows easy expansion of the error detection system by additional sensors 13 or transmitters 12.

The error detection system of the invention can be used with various G-suits 11 and aircrafts, since it is self-sufficient and does not rely on components of the G-suit 11 or of the aircraft. The pressure within the G-suit 11 is established via conduit 21.

Portability of the pressure sensing unit 13 is preferably increased by wireless data communication 14, 15 between pressure sensing unit 13, transmitter 12 and/or receiver 16.

The pressure sensing unit 13 may be provided in a rounded housing, preferably made of plastic or metal. The housing is preferably small, e.g. as a palm of a hand or even smaller.

The pressure sensing unit may be a differential pressure sensor, or may be an absolute pressure sensor. Various types of pressure sensors can be used, according to the invention. Preferred pressure sensors are the following:

Fiber optic sensors: This technology uses the properties of fiber optics to affect light propagating in a fiber such that it can be used to form sensors. Pressure sensors can be made by constructing miniaturized fiber optic interferometers to sense nanometer scale displacement of membranes. Pressure can also be made to induce loss into a fiber to form intensity based sensors.
Mechanical deflection sensors: This technology uses the mechanical properties of a liquid to measure its pressure. Such as, the effect of pressure on a spring system and the changes of compression of spring can be used to measure pressure.
Strain gauge sensors: A strain gauge makes use of the changes in resistance that some materials experience due to change in its stretch or strain. This technology makes use of the change of conductivity of material when experiencing different pressures and calculates that difference and maps it to the change of pressure.
Semiconductor piezoresistive sensors: This technology uses the change in conductivity of semiconductors due to the change in pressure to measure the pressure.
Microelectromechanical systems (MEMS): This technology combines microelectronics with tiny mechanical systems into microelectromechanical systems such as valves, gears, and any other mechanical systems all on one semiconductor chip using nanotechnology to measure pressure.
Variable capacitance sensors: This technology uses the change of capacitance due to change of the distance between the plates of a capacitor because of change in pressure to calculate the pressure.

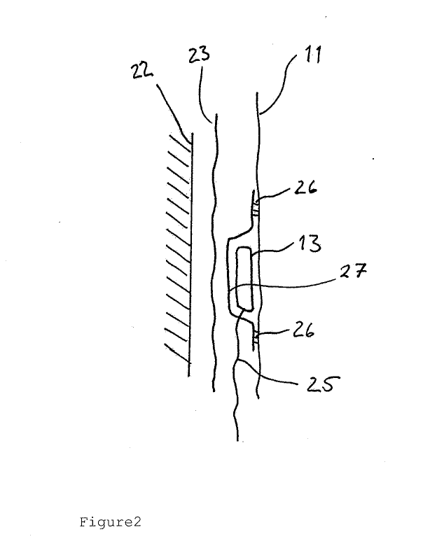

FIG. 2 shows how a pressure sensing 13 unit may be arranged between the G-suit 11 and the leg of a pilot 22. Pressure sensing unit 13 is attached to G-suit 11 in a releasable fashion 26. The pressure sensing unit is not fixedly attached to the G-suit 11. The pressure sensing means 13 is thus not un-releasably connected to the G-suit 11. (This includes a releasable connection, as well as no physical connection at all.) The pressure sensing unit 13 can be held in place in various ways. For example, pressure sensing unit 13 can be held in place by a rubber strap, said rubber strap being positioned around the pilot's leg 22. In another embodiment a hook-and-loop fastener, e.g. Velcro 26, is used to hold the pressure sensing unit 13 in place. Furthermore, a releasable connection, e.g. a pressure-sensitive adhesive 26, can be used to hold pressure sensor 13 in place. It shall be emphasized that the releasable connection 26 does not fixedly attached the pressure sensor to the G-suit 11. The pressure sensing unit 13 may also be held in place by a releasable adhesive tape or a snap fastener. Other possibilities to hold pressure sensing unit 13 in place are by magnetic means. Alternatively, a lockable pocket 27 may be used on the interior of the G-suit, provided that the lockable pocket 27 can be opened, if desired.

Preferably the pressure sensing unit 13 is separate from, i.e. not integral with, the G-suit 11. The pressure sensing unit 13 senses the pressure applied by the G-suit 11 on the pilot's leg 22, which roughly corresponds to the established pressure within the G-suit 11.

The system of this invention monitors the pressure of a pilot's G-suit 11. In case that the pressure of the G-suit exceeds certain pressure limits, the error detection system warns the pilot immediately that a malfunction has occurred

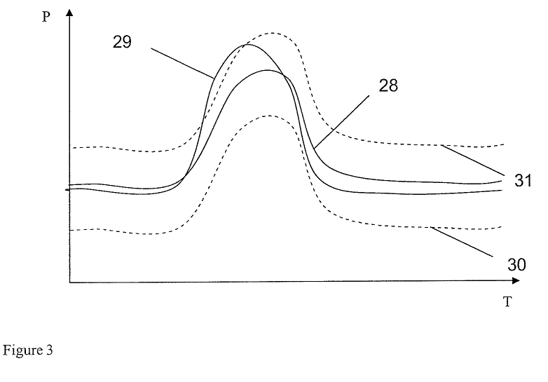

FIG. 3 shows a typical pressure versus time distribution of a flight maneuver. The expected pressure distribution in the G-suit 11 during this flight maneuver is shown as curve 28. Line 30 and 31 specify the pressure tolerance band which defines the boundaries of the allowed pressure range. If the error detection system detects pressure data outside of this tolerance band then an alarm signal is triggered. Assuming that the pilot is suddenly performing a climb flight after he did a level flight, the pressure should follow curve 28. The actual pressure within the G-suit 11, expressed by curve 29, runs outside the pressure tolerance band 30, 31. Thereupon the error detection system issues an alarm signal.

Transmitter 12 collects pressure measurement data coming from the pressure sensing unit 13 and processes the received data. Processing of received data may include data encoding and/or data compression.

Receiver 16 preferably establishes the link between transmitter 12 and error detection unit 19. Error detection unit 19 evaluates the measured pressure data. Error detection unit 19 may be included in the aircraft computer 17.

In case of malfunction an alarm signal may be displayed on a display unit 20 of the aircraft. This warns the pilot when a malfunction of the pressure control system occurs.

In one embodiment of the invention the error detection unit 19 analyzes the pressure data, and in case of a malfunction the display unit 20 of the aircraft computer 17 is activating an error code with a short description appearing on the screen of the aircraft cockpit. This serves as a warning to the pilot. Error detection unit 19 may also trigger a signal that is sent to the ground control station. This signal may consist of a report. Preferably the report does not only contain information about the detected error, but also contains information on the state of health of the pilot, if available, and on the condition of the aircraft. This allows the ground control station to take control over the aircraft, if required.

The error detection unit 19 may be able to actuate the auto pilot of the aircraft, when an error condition occurs. The error detection unit 19 preferably logs pressure data during flight. The error detection unit 19 may also be able to create a report comprising physical parameters such as G-force, acceleration, speed, angular rate, altitude, or environmental parameters.

The error detection unit 19 as well as transmitter 12 and pressure sensing unit 13 (and additional sensors used to capture biological data) are preferably equipped with a memory unit. This memory unit may be adapted to record data.

A particularly preferred feature of the system of the present invention is that the error detection is achieved by comparison of measured pressure data with expected pressure data. The expected pressure data is preferably obtained from a simulation. The simulation model preferably uses a physical model.

The simulation model calculates expected pressure data from various parameters, such as measured G-force, vertical and/or horizontal acceleration, flight path angle, altitude, speed, and flight control information. The calculation of the expected pressure data can be based on a mathematical formula, a look-up table, or can be based on fuzzy logic or on a neural net.

The simulation model of error detection unit 19 preferably comprises a learning functionality. It is preferably capable of analyzing e.g. pressure of G-suit, biological parameters, altitude, G-force, speed, acceleration, flight path angle, wind, precipitation) the learning functionality thus adapts the algorithm to unprecedented flight conditions. Additionally the recorded data may be used for analyzing the pilots' behavior during a flight. In this case it is advantageous that physical parameters are available from biological sensors.

In a preferred embodiment the simulation model calculates the expected pressure data directly from a measured G-force, using a mathematical formula, or the expected pressure data is established from a look-up table. The look-up table conveniently contains G-forces and the corresponding expected pressure data. A mapping of detected G-forces onto expected pressure data is performed. Preferably, the mapping of G-forces onto expected pressure data comprises interpolation of the data in the look-up table. The look-up table may contain historical data, such as historical G-force data and corresponding historical pressure data. For example, a climb flight may impose 5G on a pilot's body and thereupon a pressure of approximately 50 kPa may be generated in the pants of the G-suit 11.

The simulation models used for the calculation of expected pressure data may be adapted to different aircraft types, to account for a different flight behavior in same flight situations.

1. An error detection system for the detection of a malfunction of a pressure control system for a G-suit, said error detection system comprising:
a pressure sensing unit for establishing pressure data representing the pressure in said G-suit,
a transmitter communicating with said pressure sensing unit, said transmitter transmitting said pressure data to a receiver,
a receiver for receiving said pressure data from said transmitter, and
an error detection unit connected to said receiver for detecting a malfunction of said pressure control system using said pressure data,
wherein said pressure sensing unit is adapted to be worn between the G-suit and a wearer of said G-suit, and wherein said pressure sensing unit is not fixedly attached to said G-suit.

2. The system according to claim 1, wherein said receiver stands in wireless connection to said transmitter.

3. The system according to claim 1, wherein said pressure sensing unit comprises multiple pressure sensors.

4. The system according to claim 1, further comprising:
a sensor for sensing a biological parameter.

5. The system according to claim 4, wherein said transmitter is adapted to process at least one of said pressure data or data from said sensor for sensing a biological parameter prior to transmitting.

6. The system according to claim 1, wherein at least one of said transmitter or said pressure sensing unit comprises a memory unit for recording pressure data.

7. The system according to claim 1, wherein at least one of said transmitter or said pressure sensing unit comprises a portable source of electrical energy.

8. The system according to claim 1, wherein said transmitter and said pressure sensing unit are combined to a single unit.

9. The system according to claim 1, wherein said detection of a malfunction comprises comparison of said pressure data with expected pressure data.

10. The system according to claim 9, wherein said expected pressure data is obtained by simulation.

11. The system according to claim 1, further comprising:
an alarm system for providing an alarm signal upon detection of said malfunction.

12. A method for the detection of an error in a pressure control system of a G-suit, said method comprising:
establishing pressure data representing the pressure in a G-suit using a pressure sensing unit,
transmitting said pressure data by a transmitter connected to said pressure sensing unit;
receiving said pressure data by a receiver from said transmitter, and
detecting a malfunction of said pressure control system from said pressure data using an error detection unit connected to said receiver,
wherein said pressure data is established by a pressure sensor unit adapted to be worn between the G-suit and a wearer of the G-suit, and wherein said pressure sensing unit is not fixedly attached to the G-suit.

13. The method according to claim 12, wherein said transmitting of said pressure data is by wireless transmission.

14. The method according to claim 12, wherein said detection of a malfunction is by comparison of said pressure data with expected pressure data obtained by simulation.

15. The method according to claim 12, further comprising:
providing an alarm signal upon detection of said malfunction using an alarm system.
